(19) United States
(12) Patent Application Publication
(10) Pub. No.: US 2007/0290142 A1
(43) Pub. Date: Dec. 20, 2007

(54) X-ray detectors with adjustable active area electrode assembly

(75) Inventors: Yanfeng Du, Rexford, NY (US); John Eric Tkaczyk, Delanson, NY (US); Wen Li, Clifton Park, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: General Electeric Company

(21) Appl. No.: 11/454,532

(22) Filed: Jun. 16, 2006

(51) Int. Cl. G01T 1/24

(52) U.S. Cl. 250/370.09

(57) ABSTRACT

An electrode assembly having an adjustable active area is provided. The electrode assembly is configured to detect photons. The electrode assembly includes a central readout electrode, and one or more bias control portions. The bias control portions are disposed adjacent to the central readout electrode. The active area is altered by controlling voltages of the bias control portions relative to a voltage of the central readout electrode.

### BACKGROUND

The invention relates generally to radiographic detectors for diagnostic imaging, and more particularly to accommodating high flux rates in direct conversion detectors, such as in computed tomography (CT) applications.

Radiographic imaging systems, such as X-ray and computed tomography (CT) have been employed for observing, in real time, interior aspects of an object. Typically, the imaging systems include an X-ray source that is configured to emit X-rays toward an object of interest, such as a patient or a piece of luggage. A detecting device, such as an array of radiation detectors, is positioned on the other side of the object and is configured to detect the X-rays transmitted through the object.

Conventional CT and other radiographic imaging systems utilize detectors that convert radiographic energy into current signals that are integrated over a time period, then measured and ultimately digitized. A drawback of such detectors however is their inability to provide data or feedback as to the number and/or energy of photons detected. Also, energy discriminating, direct conversion detectors capable of not only X-ray counting, but also providing a measurement of the energy level of each X-ray detected have been employed in CT systems. However, a drawback of these direct conversion detectors is their inability to count at the X-ray photon flux rates typically encountered with conventional CT systems. Further, the very high X-ray photon flux rate has been known to cause pile-up that ultimately leads to detector saturation. “Pile-up” is a phenomenon that occurs when a source flux at the detector is so bright that there is a non-negligible possibility that two or more X-ray photons deposit charge packets in a single pixel during one read-out cycle. In such a case these events are recognized as one single event having the sum of their energies. If this happens sufficiently often, events are shifted in the spectrum to higher energies. In addition, pile-up leads to a more or less pronounced depression of counts in high X-ray flux, resulting in detector quantum efficiency (DQE) loss.

Further, as will be appreciated, these detectors typically saturate at relatively low X-ray flux levels (10-30 Mcps/mm²). Detector saturation leads to loss of imaging information and consequently results in noise and artifacts in X-ray projection and CT images. Photon counting direct conversion detectors are known to suffer from decreased detector quantum efficiency (DQE) at high count rates mainly due to detector pile-up. In a direct conversion photon counting system, the output signal width (dead time) for each x-ray photon event is limited by the intrinsic charge collection time and the readout electronics shaping time. As indicated above, saturation ultimately is often due to pulse pile-up, particularly when the X-ray photon absorption rate for each pixel is on the order of the inverse of this dead time. The reciprocal of the dead time is called a maximum periodic rate (MPR). When the true mean X-ray count rate incident on the detector is equal to the maximum periodic rate, the DQE is one half and the output count rate recorded is only one half the input count rate. Reduced DQE results in reduced image quality, i.e., a noisy image. In addition, hysteresis and other non-linear effects occur at flux levels near detector saturation as well as flux levels over detector saturation and lead to image artifacts.

Previously conceived solutions to enable photon counting at high X-ray flux rates include using bowtie shaped filters to pre-shape the profile of the flux rate along the detector, compensating for the patient shape and producing a smaller dynamic range of flux across the field of the detector. Also it has been proposed to subdivide the pixel into multiple sub-pixels, each sub-pixel connected to its own preamplifier. By reducing the area of the direct conversion sub-pixel the flux rate capability may be increased as fewer photons are collected in the smaller area. However, the signal-to-noise ratio of the resulting signal may be reduced, and the level of cross-talk will be disadvantageously significant due to the increased perimeter between sub-pixels. Crosstalk in a direct conversion detector takes the form of charge sharing between pixels for x-rays that are absorbed near the boundaries between pixels. Charge sharing may cause the photon to be missed entirely or mislabeled in energy. In either case, the DQE is decreased and spectral response is of reduced fidelity as a result of using subdivided pixels, each connect to its own amplifier.

There is therefore a need for an energy discriminating detector that does not saturate at the X-ray photon flux rates typically found in conventional radiographic systems. In particular, there is a significant need for a design that advantageously accommodates high flux rates without adversely affecting the image quality at low flux rates.

### BRIEF DESCRIPTION

In accordance with aspects of the present technique, an electrode assembly is provided. The electrode assembly includes an adjustable active area configured to detect photons. The electrode assembly further includes a central readout electrode, and one or more bias control portions. The bias control portions are disposed adjacent to the central readout electrode. The active area is altered by controlling voltages of the bias control portions relative to a voltage of the central readout electrode.

In accordance with another aspect of the present technique, an X-ray detector is provided. The X-ray detector is configured to detect the stream of radiation and to generate one or more signals responsive to the stream of radiation. The detector includes a plurality of electrode pixels, wherein each of the plurality of electrode pixels is configured to detect incident photons. The electrode pixels include a readout electrode, and one or more bias control portions. The bias control portions are disposed adjacent to the central readout electrode. Further, a voltage of the bias control portions is controlled to define an active area of the electrode pixels.

In accordance with further aspects of the present technique, a method of using an X-ray imaging detector is provided. The method includes monitoring photon flux rate incident on the plurality of electrode pixels. The method further includes adjusting an active area of at least one of the plurality of electrode pixels by altering a voltage of one or more bias control portions of the plurality of electrode pixels relative to a voltage of the readout electrode of the plurality of electrode pixels depending on the flux rate of the photons.

### DRAWINGS

These and other features, aspects, and advantages of the present invention will become better understood when the following detailed description is read with reference to the accompanying drawings in which like characters represent like parts throughout the drawings, wherein:

FIG. 1 is a block diagram of an exemplary imaging system in the form of a CT imaging system employing an X-ray detector, in accordance with aspects of the present technique;

FIG. 2 is a block diagram of a physical implementation of the CT imaging system of FIG. 1;

FIG. 3 is a top view of an exemplary embodiment of an electrode assembly employing a central readout electrode and bias control portions, in accordance with aspects of the present technique;

FIGS. 4 and 5 are diagrammatical representations of electronics employed to the electrode assembly for dynamically changing the active area of the electrode assembly; and

FIGS. 6-11 are top views of exemplary alternate embodiments of arrays of electrode pixels having adjustable active area, in accordance with aspects of the present technique;

FIG. 12 is a flow chart illustrating an exemplary process of receiving high and low flux rates at electrode assembly, in accordance with aspects of the present technique.

### DETAILED DESCRIPTION

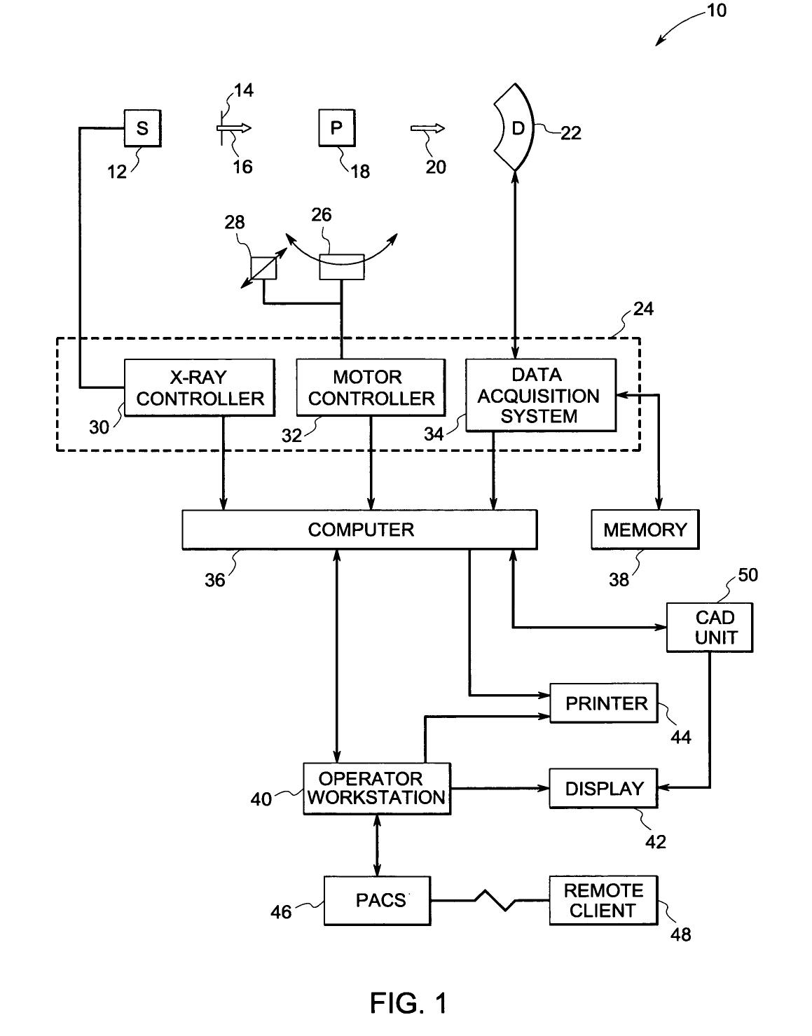

FIG. 1 is a block diagram showing an imaging system 10 for acquiring and processing projection data in accordance with the present technique. In the illustrated embodiment, the system 10 is a computed tomography (CT) system designed to acquire X-ray projection data at high flux rates, to construct an image from the projection data in accordance with the present technique. It should be noted, moreover, that aspects of the present technique may find application outside the field of CT imaging. For example, the invention may also be applied in conventional digital X-ray imaging, X-ray tomosynthesis, digital X-ray mammography, and any other digital radiographic imaging setting where a detector is used to receive photon flux and produce corresponding electronic signals. Similarly, while the particular application of the techniques to medical imaging is described below, other technical fields may make use of the invention, such as for part inspection, baggage and parcel inspection, and so forth.

In the embodiment illustrated in FIG. 1, the imaging system 10 includes a source of X-ray radiation 12, such as an X-ray tube. The source of X-ray radiation 12 may include thermionic or solid-state electron emitters directed at an anode to generate X-rays or, indeed, any other emitter capable of generating X-rays having a spectrum and energy useful for imaging a desired object. Examples of suitable electron emitters include tungsten filament, tungsten plate, field emitter, thermal field emitter, dispenser cathode, thermionic cathode, photo-emitter, and ferroelectric cathode.

The source of radiation 12 may be positioned near a collimator 14, which may be configured to shape a stream of radiation 16 that is emitted by the source of radiation 12. The stream of radiation 16 passes into the imaging volume containing the subject to be imaged, such as a human patient 18. The stream of radiation 16 may be generally fan-shaped or cone-shaped, depending on the configuration of the detector array, discussed below, as well as the desired method of data acquisition. A portion 20 of radiation passes through or around the subject and impacts a detector array, represented generally at reference numeral 22. Detector elements of the array produce electrical signals that represent the intensity of the incident X-ray beam. These signals are acquired and processed to reconstruct an image of the features within the subject.

The radiation source 12 is controlled by a system controller 24, which furnishes both power, and control signals for CT examination sequences. Moreover, the detector 22 is coupled to the system controller 24, which commands acquisition of the signals generated in the detector 22. The system controller 24 may also execute various signal processing and filtration functions, such as for initial adjustment of dynamic ranges, interleaving of digital projection data, and so forth. In general, system controller 24 commands operation of the imaging system to execute examination protocols and to process acquired data. In the present context, system controller 24 also includes signal processing circuitry, typically based upon a general purpose or application-specific digital computer, associated memory circuitry for storing programs and routines executed by the computer, as well as configuration parameters and projection data, interface circuits, and so forth.

In the embodiment illustrated in FIG. 1, the system controller 24 is coupled via a motor controller 32 to a rotational subsystem 26 and a linear positioning subsystem 28. In one embodiment, the rotational subsystem 26 enables the X-ray source 12, the collimator 14 and the detector 22 to be rotated one or multiple turns around the patient 18. In other embodiments, the rotational subsystem 26 may rotate only one of the source 12 or the detector 22 or may differentially activate various stationary electron emitters to generate X-ray radiation and/or detector elements arranged in a ring about the imaging volume. In embodiments in which the source 12 and/or detector 22 are rotated, the rotational subsystem 26 may include a gantry. Thus, the system controller 24 may be utilized to operate the gantry. The linear positioning subsystem 28 enables the patient 18, or more specifically a patient table, to be displaced linearly. Thus, the patient table may be linearly moved within the gantry to generate images of particular areas of the patient 18.

Additionally, as will be appreciated by those skilled in the art, the source of radiation 12 may be controlled by an X-ray controller 30 disposed within the system controller 24. Particularly, the X-ray controller 30 is configured to provide power and timing signals to the X-ray source 12.

Further, the system controller 24 is also illustrated as including a data acquisition system 34. In this exemplary embodiment, the detector 22 is coupled to the system controller 24, and more particularly to the data acquisition system 34. The data acquisition system 34 receives data collected by readout electronics of the detector 22. The data acquisition system 34 typically receives sampled analog signals from the detector 22 and converts the data to digital signals for subsequent processing by a computer 36.

The computer 36 typically is coupled to or incorporates the system controller 24. The data collected by the data acquisition system 34 may be transmitted to the computer 36 for subsequent processing and reconstruction. The computer 36 may include or communicate with a memory 38 that can store data processed by the computer 36 or data to be processed by the computer 36. It should be understood that any type of memory configured to store a large amount of data might be utilized by such an exemplary system 10. Moreover, the memory 38 may be located at the acquisition system or may include remote components, such as network accessible memory media, for storing data, processing parameters, and/or routines for implementing the techniques described below.

The computer 36 may also be adapted to control features such as scanning operations and data acquisition that may be enabled by the system controller 24. Furthermore, the computer 36 may be configured to receive commands and scanning parameters from an operator via an operator workstation 40, which is typically equipped with a keyboard and other input devices (not shown). An operator may thereby control the system 10 via the input devices. Thus, the operator may observe the reconstructed image and other data relevant to the system from computer 36, initiate imaging, and so forth.

A display 42 coupled to the operator workstation 40 may be utilized to observe the reconstructed images. Additionally, the scanned image may also be printed by a printer 44, which may be coupled to the operator workstation 40. The display 42 and printer 44 may also be connected to the computer 36, either directly or via the operator workstation 40. The operator workstation 40 may also be coupled to a picture archiving and communications system (PACS) 46. It should be noted that PACS 46 might be coupled to a remote system 48, such as radiology department information system (RIS), hospital information system (HIS) or to an internal or external network, so that others at different locations may gain access to the projection data.

It should be further noted that the computer 36 and operator workstation 40 may be coupled to other output devices, which may include standard or special purpose computer monitors and associated processing circuitry. One or more operator workstations 40 may be further linked in the system for outputting system parameters, requesting examinations, viewing images, and so forth. In general, displays, printers, workstations, and similar devices supplied within the system may be local to the data acquisition components, or may be remote from these components, such as elsewhere within an institution or hospital, or in an entirely different location, linked to the image acquisition system via one or more configurable networks, such as the Internet, a virtual private network or the like.

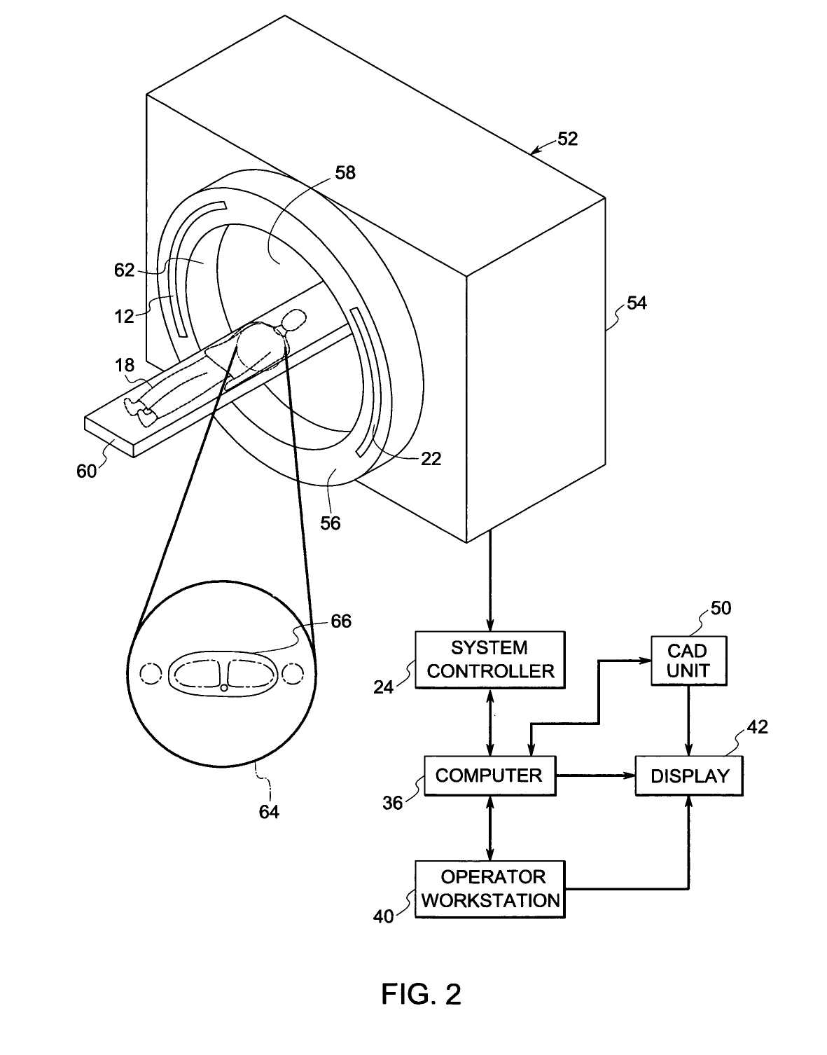

As noted above, an exemplary imaging system utilized in a present embodiment may be a CT scanning system 50, as depicted in greater detail in FIG. 2. The CT scanning system 50 may be a multi-slice CT (MSCT) system that offers a wide array of axial coverage, high rotational speed of the gantry, and high spatial resolution. Alternately, the CT scanning system 50 may be a volumetric CT (VCT) system utilizing a cone-beam geometry and an area detector to allow the imaging of a volume, such as an entire internal organ of a subject, at high or low gantry rotational speeds. The CT scanning system 50 is illustrated with a frame 52 and a gantry 54 that has an aperture 56 through which a patient 18 may be moved. A patient table 58 may be positioned in the aperture 56 of the frame 52 and the gantry 54 to facilitate movement of the patient 18, typically via linear displacement of the table 58 by the linear positioning subsystem 28 (see FIG. 1). The gantry 54 is illustrated with the source of radiation 12, such as an X-ray tube that emits X-ray radiation from a focal point 62.

In typical operation, the X-ray source 12 projects an X-ray beam from the focal point 62 and toward detector array 22. The collimator 14 (see FIG. 1), such as lead or tungsten shutters, typically defines the size and shape of the X-ray beam that emerges from the X-ray source 12. The detector 22 is generally formed by a plurality of detector elements, which detect the X-rays that pass through and around a subject of interest, such as the heart or chest. Each detector element produces an electrical signal that represents the intensity of the X-ray beam at the position of the element during the time the beam strikes the detector. The gantry 54 is rotated around the subject of interest so that a plurality of radiographic views may be collected by the computer 36.

Thus, as the X-ray source 12 and the detector 22 rotate, the detector 22 collects data related to the attenuated X-ray beams. Data collected from the detector 22 then undergoes pre-processing and calibration to condition the data to represent the line integrals of the attenuation coefficients of the scanned objects. The processed data, commonly called projections, may then be filtered and back projected to formulate an image of the scanned area. A formulated image may incorporate, in certain modes, projection data for less or more than 360 degrees of rotation of the gantry 54.

Once reconstructed, the image produced by the system of FIGS. 1 and 2 reveals internal features 66 of the patient 18. In traditional approaches for the diagnosis of disease states, and more generally of medical conditions or events, a radiologist or physician would consider the reconstructed image 64 to discern characteristic features of interest. In cardiac imaging, for example, such features 66 include coronary arteries or stenotic lesions of interest, and other features, which would be discernable in the image, based upon the skill and knowledge of the individual practitioner. Other analyses may be based upon capabilities of various algorithms, such as algorithms generally referred to as computer aided detection or computer aided diagnosis (CAD) algorithms.

In one embodiment, an X-ray detector 22 is configured to detect the stream of incident radiation and to generate one or more signals responsive to the stream of radiation. It should be noted that each detector element of a detector is commonly referred to as a “pixel”. In a conventional sense, then, the pixel generally represents the smallest area unit that can be resolved by the detector. The radiation, such as radiation 20, impacting the detector 22 may have high flux rates for incident photons of radiation 20. High flux rates may result in pile-up and polarization, which may lead to detector saturation. If the detector operates in or near the saturation flux, the output signal may have same value with different objects. The detector saturation not only causes the contrast information to be lost in the saturation region, but also induces artifacts in non-saturated regions. Therefore, there is a need for a detector 22 that does not saturate at high flux rates.

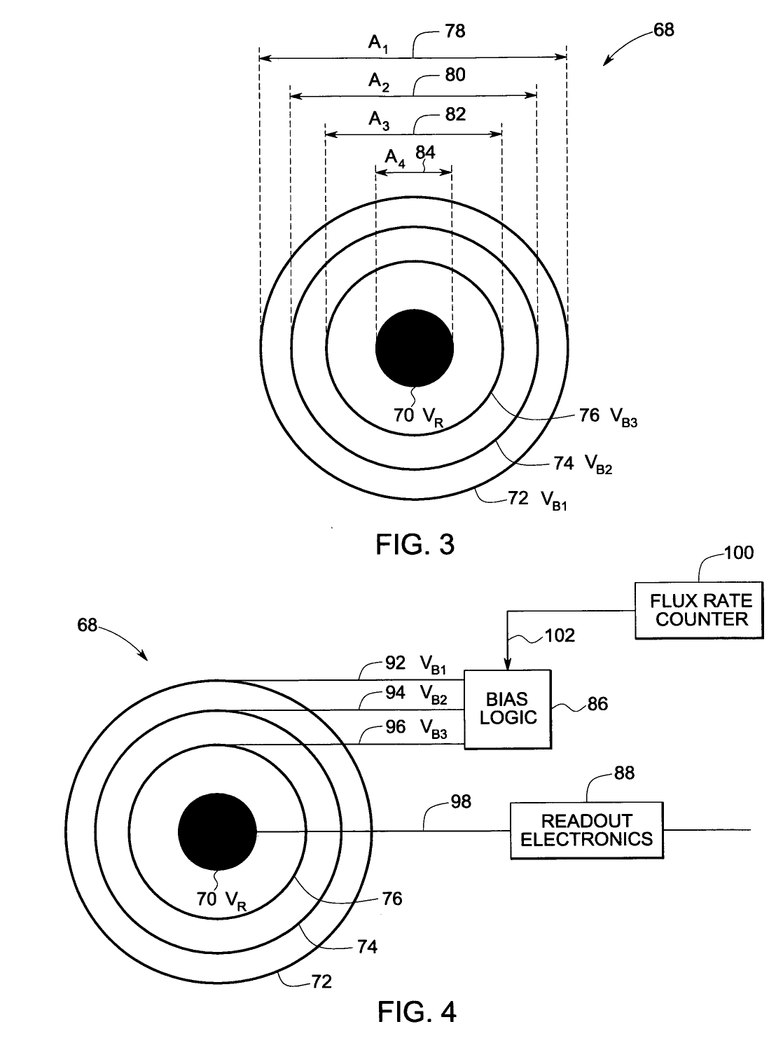

As will be described in detail below with regard to FIGS. 3-12, in certain embodiments, the detector 22 may employ a plurality of electrode pixels, wherein each of the plurality of electrode pixels has an adjustable active area to receive incident photons or electrons. In certain embodiments, the detector 22 having the adjustable area electrode pixels may be configured to accommodate high flux rates without adversely affecting the image quality. In one embodiment, the detector 22 may be a direct conversion detector. For example, the detector 22 may be a CZT detector.

It should be noted that the terms electrode assembly and electrode pixels may be used interchangeably. Further, the terms count rate referring to counts per second and flux rate referring to counts per sec per unit area may be used interchangeably throughout the application. Also, it should be noted that the term “central readout electrode” does not indicate the physical location of the central readout electrode in the electrode assembly. In other words, the central readout electrode does not necessarily have to be central to the electrode assembly or pixels but may be disposed adjacent to the bias control portions. However, the central readout electrode may be disposed proximate to the bias control portions so as to dynamically change the active area of the electrode assembly. Additionally, the bias control portions do not necessarily have to enclose the area of the central readout electrode.

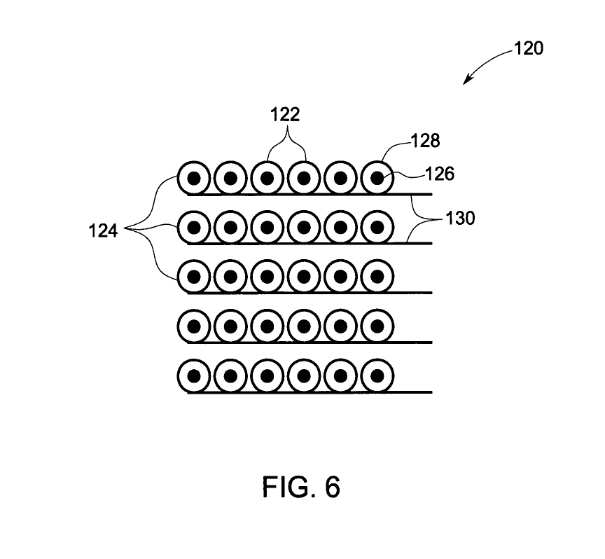

As will be described in detail below with regard to FIGS. 6-11, in certain embodiments of the present technique, a detector, such as a detector 22, may employ an electrode assembly having an active area, which is configured to detect photons such that the active area may be dynamically adjustable based upon the incident flux on the electrode assembly. In other words, the active area of the electrode assembly may be adjusted during the operation of the detector 22. In these embodiments, the active area of the electrode assembly may be decreased for high flux rates, and increased for low flux rates. The control of the active area may be configured in response to the instantaneous flux rate, the flux rate previously measured or to a prediction of the flux rate to be encountered next.

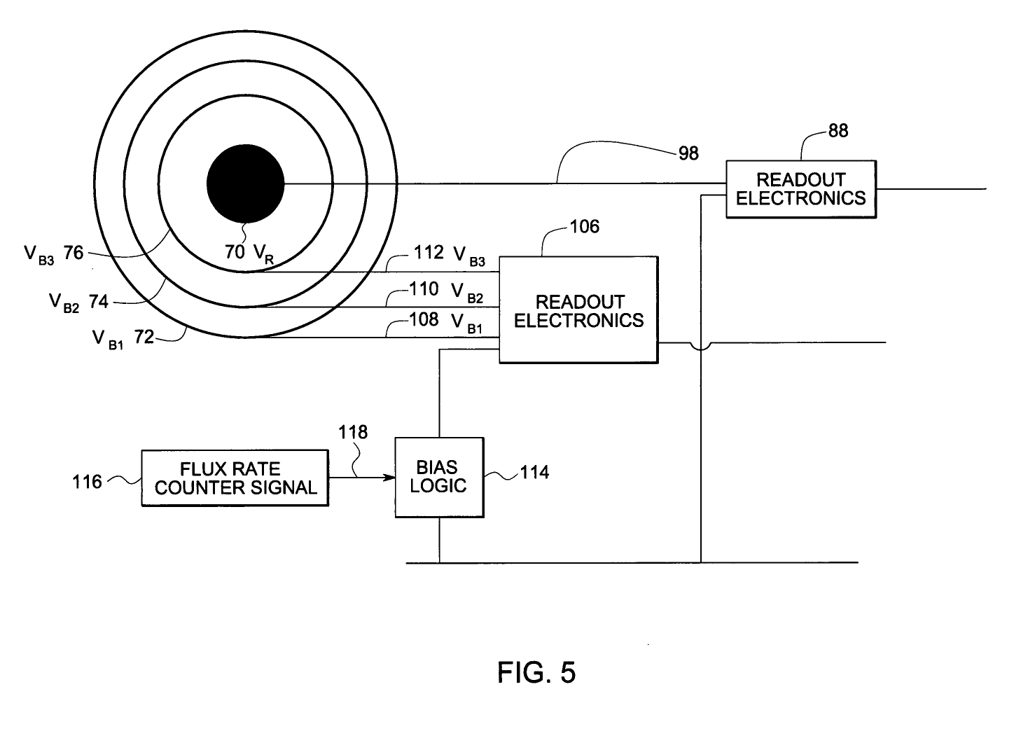

In certain embodiments, the electrode assembly may include a central readout electrode in combination with one or more bias control portions. The bias control portions may be disposed adjacent to the central readout electrode to enclose the central readout electrode. The readout electrode will typically be connected to the readout electronics 88. Further, the number of bias control portions employed in an electrode assembly of a detector may vary depending on the values of incident flux rate dynamic range. For example, the number of bias control portions employed in the electrode assembly may be in a range of from about 1 to about 5. For example, for the flux rates in a range of from about 50 Mcps to about 100 Mcps, the number of bias control portions employed in the electrode assembly may be in a range of from about 1 to about 5. Although, described herein are the embodiments where the number of bias control portions is 5 and under, however, the number of bias control portions is not limited to 5. The number of bias control portions may depend on parameters, such as the flux rates. Other than the values of the flux rates, the number of control portions employed in an electrode assembly may also depend on the limitations posed by the fabrication techniques being employed to make the electrode assembly. In one embodiment, the electrode assembly may be fabricated using techniques such as low temperature soldering. Additionally, the number of bias control portions may also be chosen based upon the routing and available for the electrode assembly. For example, as will be described in detail below with regard to FIGS. 4 and 5, each bias control portion in the electrode assembly needs to be electrically coupled to a bias logic. Therefore, the number of bias control portions may also depend on the space constraint for the routing of each electrode assembly on the detector 22.

In one embodiment, the central readout electrode may be in the shape of a circle, a square, a rectangle, a polygon, or a combination of two or more thereof. In one embodiment, the bias control portions are in a shape of a ring, an annular disc, an ellipse, a bar, a square, a rectangle, or a combination of two or more thereof. As will be described in detail below with regard to FIGS. 3-11, different combinations of the shape of the central readout electrode and central control portions may be employed depending on the desired end shape of the electrode assembly.

Accordingly, the active area of the electrode assembly may be dynamically changed depending on the flux rate. The active area of the electrode assembly may be adjusted by controlling voltages of the bias control portions relative to the voltage of the central readout electrode. In certain embodiments, the active area of the electrode assembly may be same as the area of the central readout electrode at high flux rate values. Accordingly, the active area is centered about the readout electrode, thereby resulting in decreased charge sharing between adjacent pixels when the readout electrode is remote from the pixel boundary and enclosed by a bias control portion. In certain embodiments, the adjustable active area is indirectly proportional to an input flux rate above a predetermined threshold flux rate so as to keep the count rate constant above the predetermined threshold. In one embodiment, the electrode assembly may include an anode. In this embodiment, the active area of the anode may be controlled depending on the flux rate of incident electrons.

As noted above, the plurality of bias control portions may be coupled to a single/common bias logic to monitor the voltages of the individual bias control portions. The bias logic may in turn be coupled to a counter, which is configured to detect the quantity of the flux rate incident on the electrode assembly. The bias logic and the flux rate counter will be described in detail with regard to FIGS. 4 and 5.

In certain embodiments, the electrode assembly may further include readout electronics in operative association with the central readout electrode. The readout electronics is configured to produce electrical signal corresponding to the current of electrons generated within the adjustable active area of the electrode assembly. As opposed to the conventional methods, in the present technique, only one readout circuitry may be required for each pixel because the signals are centrally collected from the readout electrode as opposed to the conventional techniques of measuring the signals from the readout electrode as well as from each of the bias control portions. However, as described in detail below with regard to FIG. 5, the electrode assembly of the present technique may also employ a readout electronics, which is electrically coupled to the central readout electrode as well as the bias control portions. An alternate embodiment may incorporate switches, which selectively route the charge from the bias control portions to the readout electronics based on the count rate.

Further, the detector 22 may employ a plurality of these electrode assemblies/pixels, which may be arranged in an array. The electrode pixels may be arranged in the form of one or more of a row, column, or grid to form an array. Further, in certain embodiments, two or more electrode pixels of a row may be electrically coupled to each other. In these embodiments, the two or more electrode pixels of the row may employ a common bias logic for controlling the voltage, thereby reducing the number of electronic components in the detector 22. In these embodiments, the two or more electrode pixels may be under common control. In other words, the two or more electrode pixels may be controlled regionally as opposed to individual control of each of the individual electrode pixels. The regional control may reduce the number of electronic components.

Referring now to FIG. 3, a top view of an exemplary electrode assembly 68 having an adjustable active area is illustrated. In the presently contemplated embodiment of the electrode assembly 68, the electrode assembly 68 includes a central readout electrode 70. In the illustrated embodiment, the central readout electrode 70 is in the shape of a circular disc, however, as noted above the readout electrode may be in several other forms depending on the end shape of the electrode assembly, such as assembly 68. The electrode assembly 68 further includes three bias control portions 72, 74 and 76. In the illustrated embodiment, the bias control portions are disposed adjacent to the central readout electrode 70. Further, the three bias control portions are in the form of rings. The three rings are disposed in concentric circles about the central readout electrode such that the ring representing the bias control portion 72 is farthest from the central readout electrode and the ring representing the bias control portion 76 is nearest to the central readout electrode 68. As with the central readout electrode 70, the bias control portions 72, 74 and 76 may have shapes other than rings, depending on the end shape of the electrode assembly 68.

In certain embodiments, the voltages V_{B1}, V_{B2} and V_{B3} of the bias control portions 72, 74 and 76, respectively may be adjusted relative to the voltage V_{R} of the readout electrode 70 to control the active area of the electrode assembly 68 based on the input flux rate at detector 22 (see FIG. 1).

At low flux rates in a range of from about 0 Mcps to about 30 Mcps, the voltages V_{B1}, V_{B2}, V_{B3} of the bias control portions 72, 74, 76 may be maintained at a relatively low voltage as compared to the voltage V_{R} of the read out electrode 70. In this embodiment, the active area of the electrode assembly 68 may be the entire area A₁ 78 of the electrode assembly 68. In this embodiment where the electrode assembly 68 includes an anode, the incident electrons may be focused over the entire area A₁ 78 of the electrode assembly 68. The difference in the voltage V_{R} of the readout electrode 70 and those of the bias control portions 72, 74, 76 (V_{B1}, V_{B2}, V_{B3}) may be in a range of from about 30 volts to about 100 volts to have the area 78 of the electrode assembly 68 acts as an active area.

Subsequently, as the incident flux rate increases the area of the electrode assembly 68 may be reduced. For example, in one embodiment, when the incident flux rate on the electrode assembly 68 is in a range of from about 30 Mcps to about 100 Mcps, the area of the electrode assembly 68 may be reduced to area A₂ 80, thereby making the area lying within the bias control portion 74 as the active area. In one embodiment, the area of the electrode assembly 68 may be reduced to A₂ 80 by maintaining the voltage V_{B1} of the bias control portion 72 about the same as the voltage V_{R} of the readout electrode 70.

As the incident flux increases further in a range of from about 100 Mcps to about 300 Mcps, the active area of the electrode assembly 68 may be further reduced to A₃ 82. In this embodiment, the collection area for the incident flux rate may be confined to the area lying within the bias control portion 76. The voltage V_{B2} of the bias control portion 74 may be maintained about the same as the voltage V_{R} of the readout electrode 70, thereby making the active area as the area confined within the bias control portion 76.

Further, at even higher flux rates in a range of from about 300 Mcps to about 1000 Mcps, the active area of the electrode assembly 68 may be further decreased. In this embodiment, the voltage V_{B3} of the bias control portion 76 may be maintained about the same as the voltage V_{R} of the readout electrode 70, thereby making the active area as the area A₄ 84 confined within the central readout electrode 70. It should be appreciated by those skilled in the art that material availability generally limits the flux rates experienced by the electrode assembly, such as the electrode assembly 68. However, the electrode assembly 68 may be able to experience higher flux rates with the advancement in the materials being employed in the electrode assembly 68.

Turning now to FIG. 4, the electrode assembly, such as electrode assembly 68, may be coupled to electronic circuitry including a bias logic 86 and a readout electronics 88. The bias logic 86 may be coupled to each of the individual bias control portions 72, 74 and 76 via electrical connections 92, 94 and 96, respectively. Accordingly, in certain embodiments, the number of bias control portions employed in the electrode assembly may depend on the flux rate, while in other embodiments, as noted above, the constrains in the fabrication method may also govern the number of bias control portions employed in the electrode assembly 68. The voltages V_{B1}, V_{B2} and V_{B3} of the bias control portions 72, 74 and 76, respectively may be monitored and controlled using the bias logic 86.

Further, the bias logic 86 may be in operative associated with a flux rate counter 100, which may serve as an input for the bias logic as indicated by arrow 102.

The flux rate counter 100 may detect the value of the incident flux rate. This information about the flux rate may then flow down from the flux rate counter 100 to the bias logic 86, where it is fed as an input. Depending on the inputted value of the flux rate from the flux rate counter 100, the voltages of the active area of the electrode assembly 68 is then adjusted by controlling the voltages V_{B1}, V_{B2} and V_{B3} of the bias control portions 72, 74 and 76. As describe above with regard to FIG. 3, the active area of the electrode assembly 68 may be adjusted by varying the voltages V_{B1}, V_{B2} and V_{B3} of the bias control portions 72, 74 and 76 relative to the voltage V_{R} of the central readout electrode 70.

In an exemplary embodiment, at low flux rate of about 0 Mcps to about 30 Mcps, the active area of the electrode assembly 68 may be equivalent to the entire area of the electrode assembly including the central readout electrode 70 and the bias control portions 72, 74 and 76. In this embodiment, the central readout electrode may be maintained at V_{R}=0 volts, the voltages of the control portions may be at a relatively lower values as compared to the voltage of the central readout electrode 70. For example, the voltage V_{B1}=−50 volts, V_{B2}=−40 volts, and V_{B3}=−30 volts. At higher flux rates, the active area of the electrode assembly 68 may be reduced to the area covered within the bias control portion 74. In this embodiment, the voltages may be V_{R}=0 volts, V_{B1}=0 volts, V_{B2}=−40 volts, and V_{B3}=−30 volts. As the flux rate further increases, maintaining the voltage of the bias control portion 74 same as that of the central readout electrode 70 may further reduce the active area of the electrode assembly 68. In this embodiment, the voltages of the central readout electrode and the bias control portions may be V_{R}=0 volts, V_{B1}=0 volts, V_{B2}=0 volts, and V_{B3}=−30 volts. In this embodiment, the active area may be reduced to the area lying within the bias control portion 76. At even higher flux rates of about 100 Mcps and above, the active area of the electrode assembly 68 may be restricted to the area of the central readout electrode 70. In this embodiment, the voltages of all the three bias control portions 72, 74 and 76 may be maintained at same value as the voltage of the central readout electrode 70. In one embodiment, the voltages may be V_{R}=0 volts, V_{B1}=0 volts, V_{B2}=0 volts, and V_{B3}=0 volts.

In certain embodiments, the flux rate counter 100 may be located within an application specific integrated circuit (ASIC). In these embodiments, the ASIC may either be disposed directly under the detector 22 (see FIG. 1) on the same substrate, or away from the detector 22 on a separate substrate. In some of these embodiments, the ASIC may be configured to identify the amount of voltages V_{B1}, V_{B2} and V_{B3} that are required at the bias control portions 72, 74 and 76, respectively for a given value of flux rate. In these embodiments, the electrode assembly 68 may not employ a separate bias logic 86 in addition to the flux rate counter 100. In another embodiment, the flux rate counter 100 may be located further up the signal processing flow. For example, in one embodiment, the flux rate counter 100 may be located in a digital signal processing (DSP) unit or a field programmable gate array (FPGA). These units may be disposed directly under the detector 22 (see FIG. 1) or away from the detector 22 on a separate substrate. Further, in some embodiments, the decision to change the bias of the bias control portions, such as portions 72, 74 and 76, may be made at system software level. In these embodiments, the input for the bias control portions 72, 74 and 76 may be controlled externally via switches. The switches may be controlled at the system level. These switches may be physically located on the detector, such as detector 22.

The electronic connections 92, 94 and 96 may include lead, wires, and the like. Further, the electronic connections 92, 94, 96 and the connection 98 from the central readout electrode 70 to the readout electronics 88 may be formed by low temperature soldering, for example.

Referring now to FIG. 5, an alternate topology employed in the electrode assembly in FIG. 4 is illustrated. In the illustrated embodiment, both the central readout electrode 70 and the bias control portions 72, 74 and 76 include readout electronics. In other words, the signals may be read from both the central readout electrode 70 and the bias control portions 72, 74 and 76. In this embodiment, the signals from the bias control portions 72, 74 and 76 may be read by employing readout electronics 106 electrically coupled to the bias control portions 72, 74 and 76 via electrical leads 108, 110 and 112, respectively. In an alternate embodiment, the three bias control portions 72, 74 and 76 may each have a separate readout electronics coupled thereto.

In the illustrated embodiment, the readout electronics 106 from the bias control portions 72, 74 and 76 may be coupled to a bias logic 114 to control the voltages of the bias control portions 72, 74 and 76 to adjust the active area of the electrode assembly 68 as described above with regard to FIG. 4. The bias logic 114 in turn receives input from flux rate counter 116 as indicated by arrow 118. In certain embodiments, the topology illustrated in FIG. 5 may work in a range of from about 0 Mcps to about 1000 Mcps.

Whereas FIG. 5 shows the bias control portions 72,74 and 76 configured as rings about a centrally located readout electrode 70, an alternate embodiment may include four subpixel contacts, which are similarly connected to readout electronics. Three subpixels would be configured through the bias logic 114 as bias control electrodes whereas the remaining one subpixel would serve as the readout electrode.

Turning now to FIG. 6, the detector, such as detector 22, may employ an array 120 having a plurality of electrode pixels 122 arranged in rows 124. As illustrated, each of the electrode pixels 122 includes a central readout electrode 126 and a bias portion 128 circumscribed about the central readout electrode 126. In the illustrated embodiment, the bias portions 128 of the electrode pixels 122 of each row are electrically coupled to each other via a common bias 130. The common bias 130 enables regional control of the electrode pixels 122 of a particular row. Accordingly, the different electrode pixels 122 of a particular row 124 may not have to be individually controlled, thereby reducing the amount of circuitry otherwise required while addressing each electrode pixel separately. In certain embodiments, the common bias 130 may be coupled to a bias logic (not shown) to control the voltages of the bias control portions 128 of the electrode pixels 128.

Further, different rows 124 may be configured to receive different thresholds of flux rates. In an exemplary embodiment, the rows 124 in the centre of the array 120 may be configured to receive lower flux rate as compared to the rows 124 disposed on the outside of the array 120. In this embodiment, the active area of the electrode pixels 122 of the rows 124 disposed in the center of the array 120 may be maintained greater than the active area of the electrode pixels 122 of the rows 124 disposed on the outside of the array 120 by controlling the voltages of the bias control portion 128 of the electrode pixels 122 relative to the voltages of the central readout electrode 126.

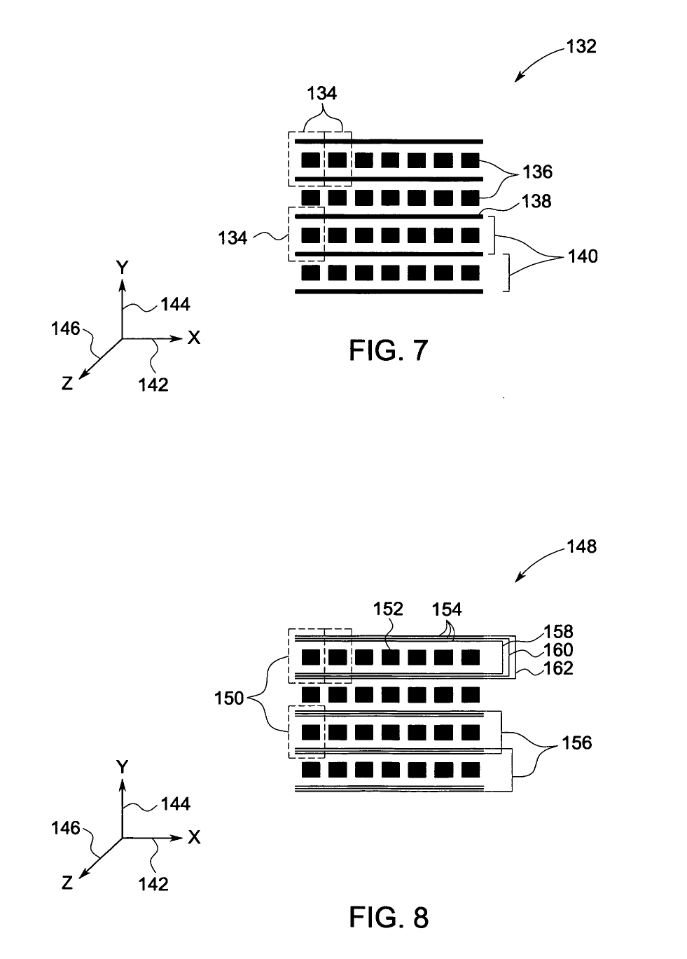

In an alternate embodiment of FIG. 6, FIG. 7 illustrates an array 132 of electrode pixels 134 having central readout electrodes 136 disposed between a pair of bias control portions 138. Since the electrode pixels 134 share bias control portions, the electrode pixels 134 are not physically separate entities. For illustrative purposes three exemplary electrode pixels are shown by dotted lines. As illustrated, each of the electrode pixels 134 has an individual central readout electrode 136. However, the adjacent/neighboring electrode pixels 134 may have common bias control portions 138. In the presently contemplated embodiment, any two adjacent rows 140 may share a bias control portion 138. In the illustrated embodiment, the bias control portions 138 are in the shape of bars. Further, in the illustrated embodiment, the bias control portions 138 of each row may also function as common bias 130 of FIG. 6. Accordingly, the bias control portion 138 may electrically couple all the electrode pixels of a particular row 140 to provide a common voltage. One or both of the bias control portion 138 of the rows 140 may be coupled to the bias logic (not shown) to adjust the active area of the electrode pixels by varying the voltage on the bias control portion 138 relative to the voltage of the central readout electrode 136. In the illustrated embodiment, the different rows 140 having a plurality of central readout electrodes 136 disposed between a pair of bias control portions 138 is be arranged along the y-axis 144. Further, each of the rows 140 is disposed in the plane formed by x-axis 142 and z-axis 146. As described above with regard to FIG. 6, different rows of the array 132 may be configured to receive different thresholds of the flux rate.

FIG. 8 illustrates an alternate embodiment of FIG. 7. In the illustrated embodiment of FIG. 8, the array 148 includes a plurality of electrode pixels 150 having a central readout electrode 152 and a plurality of bias control portions 154. In the illustrated embodiment, the electrode pixels are arranged in rows 156 stacked along the y-axis 144. The active area of the electrode pixels 150 may be adjusted between the area of the central readout electrode 152 and the areas 158, 160 and 162 between the bias control portions 154. Accordingly, in the illustrated embodiment, the electrode pixels 150 may be configured to receive a wider range of flux rate values due to more variation in the active area due to plurality of bias control portions 154. Further, the bias control portions 154 of the different rows 156 may be coupled to a bias logic (not shown) to control the voltages of the bias control portions 154. In one embodiment, the bias control portions of the different rows may be maintained at different voltages, thereby changing the active area of the electrode pixels of one row from that of the other row.

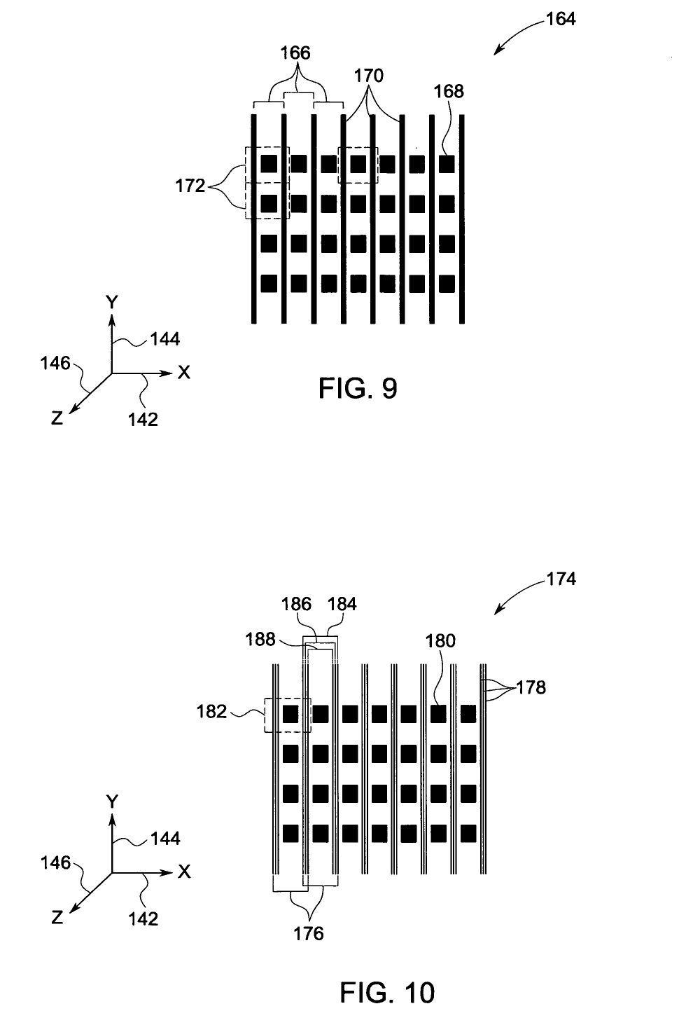

Referring now to FIG. 9, in the illustrate embodiment, the array 164 includes columns 166 of electrode pixels 172 distributed along the x-axis 142. In the illustrated embodiment, each of the columns 166 includes a central readout electrode 168 and a pair of bias control portions 170 to form electrode pixels 172. In the illustrated embodiment, the electrode pixels 172 are illustrated with dotted lines. The electrode pixels 172 in adjacent columns may have a common bias control portion 170. The bias control portion 170 may be coupled to a bias logic (not shown). The active area of the electrode pixels 172 may be varied by varying the voltages on the bias control portion 170 relative to the voltage of the central readout electrode 168. The active area of the electrode pixels 172 may be varied between the area lying between the two bias control portion 170, to the area occupied by the central readout electrode 168.

FIG. 10 illustrates an alternate embodiment of the embodiment illustrated in FIG. 9. In the illustrated embodiment, the array 174 may include columns 176 each having a plurality of bias control portions 178. The bias control portions 178 along with the central readout electrode 180 form electrode pixels 182 as indicated by dotted lines. As indicated above with regard to FIGS. 8 and 9, the active area of the electrode pixels 182 may be adjusted based on the flux rate. For low flux rates, the active area of the electrode pixel may be equal to the area 184. With increasing flux rate the active area of the electrode pixel may be reduced to area 186 and 188. At the highest value of flux rates the active area of the electrode pixel may be confined to the area of the central readout electrode 180.

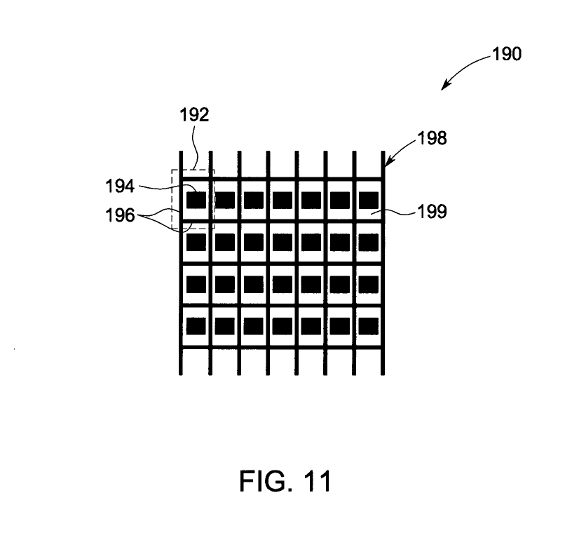

Referring now to FIG. 11, an array 190 employing electrode pixels 192 is illustrated. In the illustrated embodiment, the electrode pixels 192 include central readout electrode 194, and bias control portions 196 disposed about the central readout electrode 194. The bias control portions 196 together may form a grid 198. The grid 198 may have spaces 199 defined within, where the central readout electrodes 194 may be disposed. The active area of the electrode pixel 192 may be adjusted by changing the voltage of the bias control portions 196 relative to the central readout electrode 194. The illustrated embodiment of FIG. 11 may be economical as it is easy to fabricate, low cost, and requires low signal routing density.

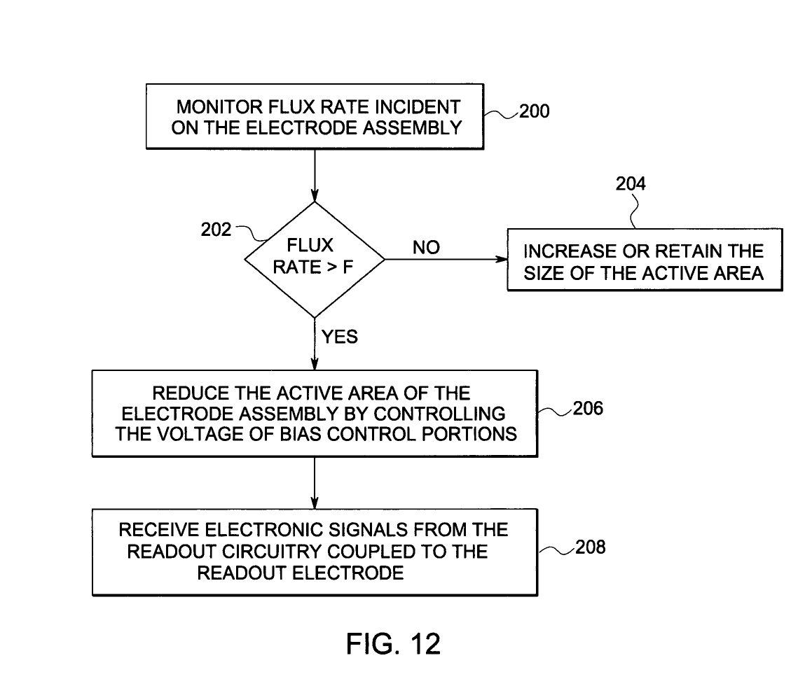

FIG. 12 is an exemplary flow chart illustrating the method for adjusting the active area of the electrode pixel. At block 200, flux rate incident on the electrode assembly is monitored. For example, the incident flux rate may be measured by employing a flux rate controller as described above with regard to FIGS. 4 and 5. At block 202, for a given value (F) of the flux rate measured at block 200, decision is made by the system, for example the flux rate controller. If the flux rate is lower than a certain determined value, F₁ (F<F₁), at block 204, the decision is made to either retain the active area of the electrode assembly or to increase the active area of the electrode assembly. Alternatively, if the value of the flux rate is found to be greater than a determined value, F₂ (F>F2, where F₁<F₂), at block 206, the active area is reduced by controlling the voltages of the bias control portions relative to that of the central readout electrode. Subsequently, at block 208, the electronic signals are read by employing a readout circuitry in operative association with the central readout electrode.

While only certain features of the invention have been illustrated and described herein, many modifications and changes will occur to those skilled in the art. It is, therefore, to be understood that the appended claims are intended to cover all such modifications and changes as fall within the true spirit of the invention.

1. An electrode assembly having an adjustable active area configured to detect photons, the electrode assembly comprising:
a central readout electrode; and
one or more bias control portions disposed adjacent to the central readout electrode, wherein the adjustable active area is altered by controlling voltages of the bias control portions relative to a voltage of the central readout electrode.

2. The electrode assembly of claim 1, wherein the central readout electrode is in a shape of a circle, a square, a rectangle, a polygon, or a combination of two or more thereof.

3. The electrode assembly of claim 1, wherein the bias control portions are in a shape of a ring, an annular disc, an ellipse, a bar, a square, a rectangle, or a combination of two or more thereof.

4. The electrode assembly of claim 1, wherein the bias control portions are concentric about the central readout electrode.

5. The electrode assembly of claim 1, wherein the adjustable active area is indirectly proportional to an input flux rate above a predetermined flux rate threshold to maintain a readout count rate above the predetermined flux rate threshold.

6. The electrode assembly of claim 1, wherein the number of bias control portions employed in the electrode assembly is in a range of from about 1 to about 10.

7. The electrode assembly of claim 1, further comprising readout electronics in operative association with the central readout electrode, wherein the readout electronics is configured to produce electrical signal corresponding to flux of photons incident on the adjustable active area of the electrode assembly.

8. The electrode assembly of claim 1, further comprising a bias logic electrically coupled to the bias control portions, wherein the bias logic is configured to alter the voltages of each of the bias control portions with respect to incident photon flux on the adjustable active area.

9. The electrode assembly of claim 8, wherein the bias logic is electrically coupled to a flux rate counter, wherein the flux rate counter is configured to monitor the incident photon flux.

10. An X-ray detector configured to detect the stream of radiation and to generate one or more signals responsive to the stream of radiation, the detector comprising a plurality of electrode pixels, wherein each of the plurality of electrode pixels is configured to detect incident photons, each of the plurality of electrode pixels comprising:
a readout electrode;
one or more bias control portions disposed adjacent to the central readout electrode, wherein a voltage of the bias control portions is controlled to define an active area of the electrode pixels.

11. The X-ray detector of claim 10, wherein each of the plurality of electrode pixels is separately controlled by a voltage controller.

12. The X-ray detector of claim 10, wherein the plurality of electrode pixels are arranged in one or more rows, wherein at least one of the bias control portions of two or more of the plurality of electrode pixels of a particular row are electrically coupled to a common voltage controller.

13. The X-ray detector of claim 10, wherein the bias control portions include one or more bars, and wherein a row of the plurality of electrode pixels is formed by positioning one or more readout electrodes between a pair of bias control portions.

14. The X-ray detector of claim 10, wherein the bias control portions are arranged in the form of a grid, wherein the grid defines spaces, and wherein one or more of the spaces are occupied by the readout electrode.

15. The X-ray detector of claim 10, wherein the readout electrode is coupled to readout electronics.

16. The X-ray detector of claim 10, wherein both the bias control portions and the readout electrode are coupled to readout electronics.

17. The X-ray detector of claim 10, wherein the X-ray detector is employed in a computed tomography imaging system.

18. A method of using an X-ray imaging detector having a plurality of electrode pixels having adjustable active area, the method comprising:
monitoring photon flux rate incident on the plurality of electrode pixels; and
adjusting an active area of at least one of the plurality of electrode pixels by altering a voltage of one or more bias control portions of the plurality of electrode pixels relative to a voltage of the readout electrode of the plurality of electrode pixels depending on the flux rate of the photons.

19. The method of claim 18, wherein the step of adjusting comprises increasing the adjustable active area of at least one of the plurality of electrode pixels at a flux rate F₁, and decreasing the adjustable active area of at least one of the plurality of electrode pixels at a flux rate F₂, wherein F₁ is lower than F₂.

20. The method of claim 18, wherein the adjustable active area of the plurality of electrode pixels is increased by subjecting the bias control portions to a voltage lower than the voltage of the readout electrode.

21. The method of claim 18, wherein the adjustable active area of the plurality of electrode pixels is decreased by maintaining a voltage of one or more bias control portions equal to the voltage of the readout electrode.

22. The method of claim 18, wherein the voltage of the bias control portions is adjusted by electrically coupling the one or more bias control portions to a single bias logic.

23. The method of claim 18, further comprising providing a read out electronics, wherein the readout electronics is coupled to the readout electrode.
